(19) United States
(12) Patent Application Publication
(10) Pub. No.: US 2002/0131748 A1
(43) Pub. Date: Sep. 19, 2002

(54) Method and mechanism for cleaning connecting-end-face of optical connector

(76) Inventor: Hiroshi Sato, Miyagi (JP)

Correspondence Address: DICKSTEIN SHAPIRO MORIN & OSHINSKY LLP, 41ST Floor, 1177 Avenue of the Americas, New York, NY, 10036-2714, US

(21) Appl. No.: 10/092,552

(22) Filed: Mar. 8, 2002

(30) Foreign Application Priority Data
Mar. 14, 2001 (JP) 72737/2001

(51) Int. Cl. G02B 6/00; G02B 6/36

(52) U.S. Cl. 385/134; 385/53; 385/147

(57) ABSTRACT

To provide a method and mechanism for reliably, quickly and easily cleaning a connecting-end-face of an optical connector. The method and mechanism bring a cleaning stick into contact with the optical connector's connecting-end-face with a constant pushing force to remove dust from the optical connector's connecting-end-face when a main body of the cleaning mechanism is positioned coaxially with the optical connector. The main body of the cleaning mechanism includes an attachment conforming to a shape of the optical connector and its housing, and a mechanism providing a predetermined, constant pushing force and, when pushed into the main body coaxially with the cleaning stick, rotating the cleaning stick. The cleaning stick is made of a material softer than that of an optical fiber, has a shape facilitating the production of an air current by its rotation, and rotates slightly eccentric from a center of the optical connector. The cleaning mechanism can easily be operated with one hand and does not require any operation skill.

### BACKGROUND OF THE INVENTION

1. Field of the Invention

The present invention relates to a method and mechanism for cleaning a connecting-end-face of an optical connector that enables connection and disconnection between optical fiber transmission lines and between an optical fiber and an optical device.

2. Description of the Related Prior Art

Because a diameter of a core of a single mode optical fiber used for an optical transmission line where optical energy concentrates and propagates is as small as 10 μm or less, contamination on the end-face of the core can cause problems such as an increase in splice loss when the end-face of the core is butted against and connected to the core of another optical fiber. Therefore, when optical fibers are interconnected through an end-face-butting optical connector, it is required that the end-face of core be kept free of contamination. A common method conventionally used is to wipe the end-face with a cleaning tool such as a cotton swab. However, the prior art has the following problems. A first problem is that contamination such as lint from the cleaning tool such as a cotton swab is left on the optical connector's end-face, which can result in an increase in splice loss after the cleaning. A second problem is that a new swab is required to be used every time cleaning is performed because if a swab were reused, dust deposited on the swab during the previous cleaning could redeposit on the optical connector's end-face. In addition, swabs used for such cleaning are expensive as compared with household swabs. A third problem is that the control of a force for pressing a swab against the fiber end-face and wiping operation during such cleaning require skills and a heavy strain is imposed on the worker because a diameter of a fiber is very small.

### SUMMARY OF THE INVENTION

The present invention has been achieved in view of the above-mentioned problems. Therefore, it is an object of the present invention to provide a method and mechanism that enables the connecting-end-face of an optical connector to be cleaned quickly, reliably and easily.

In a method of cleaning the connecting-end-face of an optical connector according to the present invention, a mechanism is used that presses the tip of a cleaning stick made of a material softer than that of the end-face of an optical connector against the end-face of the optical connector with a predetermined, constant force and rotates the cleaning stick about the central axis along the stick deviated from the center of the optical connector's end-face to remove contamination from the optical connector's end-face. The shape of the cross-section of the cleaning stick perpendicular to its axis is a rectangle and the shape along its axis is a helix. A groove is provided on its surface along the axis. The direction of rotation of the cleaning stick is determined so that a current of air is produced along the helix in the direction from the tip toward the other end when the stick rotates. The cleaning stick starts rotating before it is pressed against the connecting-end-face of the optical connector.

A mechanism for cleaning the connecting-end-face of an optical connector by bringing the tip of a cleaning stick that cleans the end-face into contact with the end-face according to the present invention comprises an attachment for fitting coaxially the tip of a cleaning mechanism containing the cleaning stick into the optical connector from the opposing directions and means for rotating the cleaning stick about the center axis along the stick to press the tip of the cleaning stick against the connecting-end-face of the optical connector. The depth at which the tip is fitted into the attachment is predetermined. The means for rotating the cleaning stick to press the stick against the connecting-end-face of the optical connector includes means for exposing the tip of the cleaning stick from the tip of the cleaning mechanism when the tip of the cleaning stick is further pushed in the direction to the optical connector beyond the predetermined depth. The rotation of the cleaning stick is eccentric rotation. The force that presses the tip of the cleaning stick against the connecting-end-face of the optical connector is a predetermined, constant force. The cleaning stick starts rotating before it is pressed against the connecting-end-face of the optical connector. The material of the cleaning stick is softer than that of the connecting-end-face of the optical connector. The cross-section of the cleaning stick perpendicular to its axis is a rectangular and the shape along its axis is a helix. The cleaning stick has a groove on its surface along the axis. The direction of the rotation is determined so that a current of air flows in the direction from the tip toward the other end along the helix when the cleaning stick rotates.

An optical connector's connecting-end-face cleaning mechanism for bringing the tip of a cleaning stick into contact with the connecting-end-face of an optical connector to clean the connecting-end-face according to the present invention comprises an attachment and a cleaning mechanism main body, wherein the tip of the cleaning mechanism containing the cleaning stick that passing through the cleaning mechanism and the optical connector are coaxially fitted into the attachment from opposing directions at their respective, predetermined depths. The cleaning mechanism main body comprises the tip and a holder. The holder is coupled with the tip through a first coil spring to fit the tip against its inner wall and slidablly hold the tip, and comprises a motor, a power supply for driving the motor, a mechanism for transmitting the rotation of the motor to the cleaning stick through a second coil spring, and a third coil spring located in the cylinder hollow of the first coil spring for performing switching operation for connecting and disconnecting the motor to and from the power supply by electrical connection/disconnection with/from the first coil spring.

When the holder is pushed toward the optical connector after the tip of the cleaning mechanism is fitted into the attachment at the predetermined depth, the cleaning stick rotates about the center axis along the stick, the tip of the cleaning stick contained in the tip of the cleaning mechanism main body is exposed from the tip and pressed against the connecting-end-face of the optical connector with a predetermined, constant force.

The cleaning stick starts rotating when the holder is pushed toward the optical connector to retract and electrically connect the first coil spring to the third coil spring, and stops rotating when the holder is pulled back from the optical connector to stretch the first coil spring to electrically disconnect it from the third coil spring.

The tip further comprises a stopper for restricting the travel of the holder in the direction to the optical connector within a predetermined distance. When the holder is pushed toward the optical connector to retract the first coil spring, a mechanism that transmits the rotation of the motor to the cleaning stick through the second coil spring pushes the cleaning stick in the hollow of the tip of the cleaning mechanism, thereby exposing the tip of the cleaning stick from the tip of the cleaning mechanism. When the holder is stopped by the stopper, the tip of the cleaning stick is pressed against the connecting-end-face of the optical connector with the predetermined, constant force. The force is set by the position of the stopper and a spring constant of the second coil spring.

The cleaning stick starts rotating before the cleaning stick is pressed against the connecting-end-face of the optical connector. The rotation of the cleaning stick is eccentric rotation. The cross-section of the cleaning stick perpendicular to its axis is a rectangle and the shape along its axis is a helix. A groove is provided on the surface along the axis. The direction of the rotation of the cleaning stick is predetermined so that a current of air flowing away from the tip along the helix is produced when the cleaning stick rotates.

### BRIEF DESCRIPTION OF THE DRAWINGS

The above and other objects, features and advantages of the present invention will become apparent from the following detailed description when taken with the accompanying drawings in which:

FIG. 1 is a schematic diagram of an optical connector's connecting-end-face cleaning mechanism according to the present invention;

FIG. 2 is a cross-sectional view of an entire optical connector's connecting-end-face cleaning mechanism according to the present invention;

FIG. 3 is a cross-sectional view of a part of the optical connector's connecting-end-face cleaning mechanism according to the present invention;

FIG. 4 is an enlarged cross-sectional view of the part of the optical connector's connecting-end-face cleaning mechanism shown in FIG. 3, in which a main body of the cleaning mechanism further pushed toward a housing of an optical connector is shown; and

FIGS. 5A and 5B are diagrams for explaining a coupling mechanism constituting a part of the optical connector's connecting-end-face cleaning mechanism according to the present invention for transmitting a rotation of a motor to a cleaning stick, in which FIG. 5A shows an external view and FIG. 5B shows a partial cutaway of the mechanism.

### DETAILED DESCRIPTION OF THE PREFERRED EMBODIMENTS

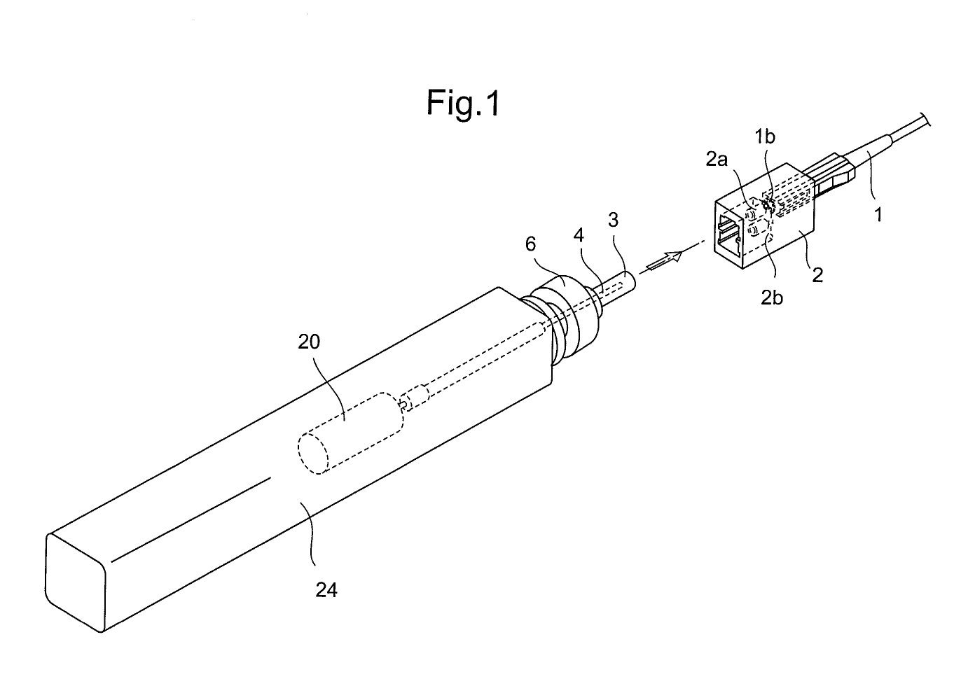

Referring to FIG. 1, an optical connector's connecting-end-face cleaning mechanism comprises a cleaning mechanism main body 24, an optical connector 1, and optical connector housing 2 into which the cleaning mechanism main body and the optical connector are inserted from both sides. The cleaning mechanism main body 24 consists largely of a cleaning stick 4, a driving section for rotating the cleaning stick 4 by a motor 20, a power supply section having a mechanism for turning on and off power supply to the motor 20, and a sliding section that houses the cleaning stick 4 through the hollow and projects from the cleaning mechanism main body 24.

The sliding section consists of an attachment 3 and a stopper 6 that restrict the distance of the entrance of the cleaning stick 4 into the optical connector housing 2 within a predetermined distance. The sliding section slides on the cleaning mechanism main body 24.

When the cleaning mechanism main body 24 is pushed toward the connecting-end-face 1b of the optical connector, the cleaning stick 4 alone is pushed out by the pressure of a spring within the cleaning mechanism main body. At the same time, the motor starts driving the cleaning stick to rotate. The rotating cleaning stick 4 is kept in contact with the optical connector's connecting-end-face 1b with a constant optimum force by the spring pressure. The cleaning stick 4 scrapes off dust on the optical connector's connecting-end-face and produces a current of air rotating around the optical connector's connecting-end-face 1b by its eccentric rotation to blow out the dust from the optical connector.

The optical connector housing 2 shown is a dual-optical-connector housing in which two optical connectors 1 can be inserted in the upper and lower parts. The optical connector 1 to be cleaned in this example has a ferrule projecting from the connector, which is a jig for ensuring the accuracy of central position of optical fiber and supporting the end of the optical fiber.

The optical connector housing 2 has two hollow cylinder guides 2a and partition plates 2b. The hollow cylinder guides radially guide the optical connector's connecting-end-face 1b and the cleaning stick 4 to bring them into contact with each other on a common axis. The ferrule of the optical connector 1 is inserted into the hollow of the hollow cylinder guide 2a and the insertion depth is restricted by the position at which the end-face of the exterior of the optical connector hits the partition plate 2b.

The attachment 3 is fitted over the hollow cylinder guide 2a. When the cleaning mechanism main body 24 is pushed toward the optical connector's connecting-end-face, the cleaning stick 4 enters the hollow of the hollow cylinder guide 2a. The depth of the insertion of attachment 3 inserted into the optical connector housing 2 is restricted by the end of the attachment hitting the partition plate 2b.

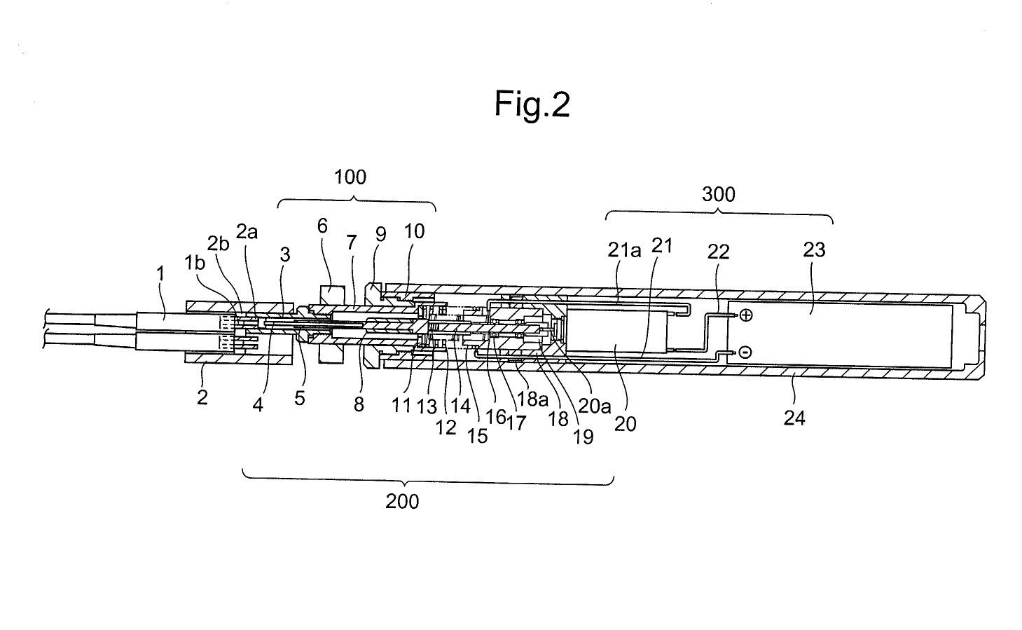

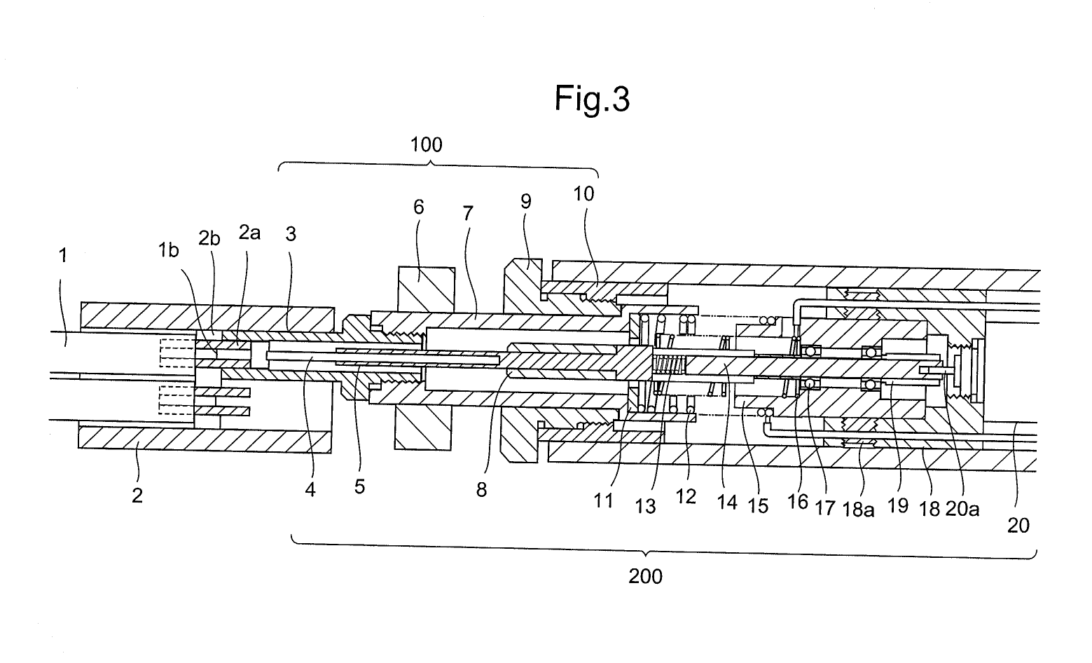

The structure of a specific embodiment of an optical connector's connecting-end-face cleaning mechanism according to the present invention will be described with reference to a general cross-sectional view shown in FIG. 2 and a partial enlarged cross-sectional view shown in FIG. 3.

The optical connector's connecting-end-face cleaning mechanism comprising a main body 24, sliding section 100, driving section 200, and power supply section 300. The sliding section 100 comprises an attachment 3 to be fitted into an optical connector housing 2 to oppose to an optical connector 1 from the opposite end and slides on the main body 24. The driving section 200 includes a cleaning stick 4, drives the cleaning stick 4 rotate it, and is housed in the cylindrical hollow of the sliding section 100 along the center axis of the hollow. The power supply section 300 supplies power to the driving section. A power supply 23 is installed in the main body 24.

The sliding section 100 comprises an attachment 3, a shaft 7 for holding the attachment 3, a stopper 6 for determining a distance to which the shaft 7 is pushed, a collar 9 for guiding the shaft 7, and a block 10 for holding the color 9.

The driving section 200 comprises the cleaning stick 4 for cleaning the connecting-end-face of the optical connector, a holder 5 for holding the cleaning stick 4, collar 8 for guiding the holder 5, a spring 13 for pressing the holder 5 against the collar 8, a shaft 14 for transmitting rotation to the holder 5, a motor 20 for rotating the shaft 14, a collar 19 for coupling the motor 20 with the shaft 14, a bearing 17 for guiding the rotation of the shaft 14, a holder 15 for housing the bearing 17, a block 18 for holding the holder 15 and the motor 20, a spring 12 for pressing the shaft 7 from the block 18 and transmitting electric power from a cord 21, a collar 11 for transmitting the electric power from the spring 12, and a spring 16 for transmitting the electric power from the collar 11.

The power supply section 300 comprises a power supply 23 for supplying electric power to the motor 20, cords 21 and 22 for transmitting the electric power from the power supply 23, and a cord 21a for transmitting the electric power from the spring 16 to the motor 20.

In this embodiment, positive electricity is supplied from the power supply 23 to the positive terminal of the motor 20 through the cord 22 and negative electricity is supplied to the collar 11 through springs 16 and 12. The power supply 23 may be a battery such as dry or secondary cells, or an AC adapter may be used.

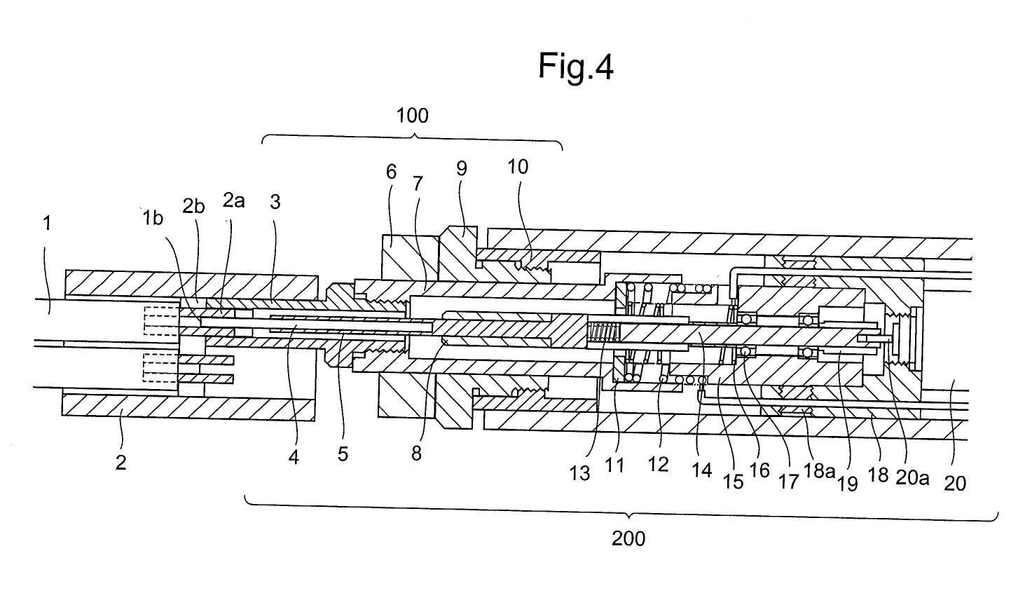

Operation of the embodiment of the present invention will be described with reference to enlarged cross-sectional views of the main part shown in FIGS. 3 and 4.

FIG. 3 shows a state in which the attachment is inserted in the optical connector housing 2 and the end of the attachment is hit against the partition plate 2b of the optical connector housing 2. A predetermined distance is maintained between the optical connector's connecting-end-face 1b and the cleaning stick 4 on a common axis. The mechanism for turning on/off power supply to the motor through the springs 12 and 16 and the collar 11 is in the off state and the rotation of the cleaning stick 4 is not yet started.

FIG. 4 shows a state in which the main body 24 shown in FIG. 3 is further pushed toward the optical connector 1. The spring 12 and spring 16 are electrically connected through the collar 11 to provide electric power to the motor. Then the cleaning stick 4 rotates while keeping contact with the optical connector's connecting-end-face 1b with a constant force to clean the end-face.

When the main body 24 is pushed toward the optical connector 1 in the state shown in FIG. 3, the collar 9 slides on the outer side of the shaft 7 and the driving section as a whole moves toward the optical connector 1. Then, the collar 11 comes into contact with the spring 16 to provide the electric power supplied to the collar 11 to the motor 20 through the springs 16 and 12. This interlocks the motor 20 with the cleaning stick 4 through the collar 19, bearing 17, shaft 14, spring 13, collar 8, and holder 5 to rotate the cleaning stick 4.

Referring to FIG. 4, when the main body 24 is pushed toward the optical connector 1, the collar 9 hits against the stopper 6 to prevent the main body 24 from moving further. The cleaning stick 4 is pressed against the optical connector's connecting-end-face 1b through the holder 8 by the force of the spring 13 and rotates.

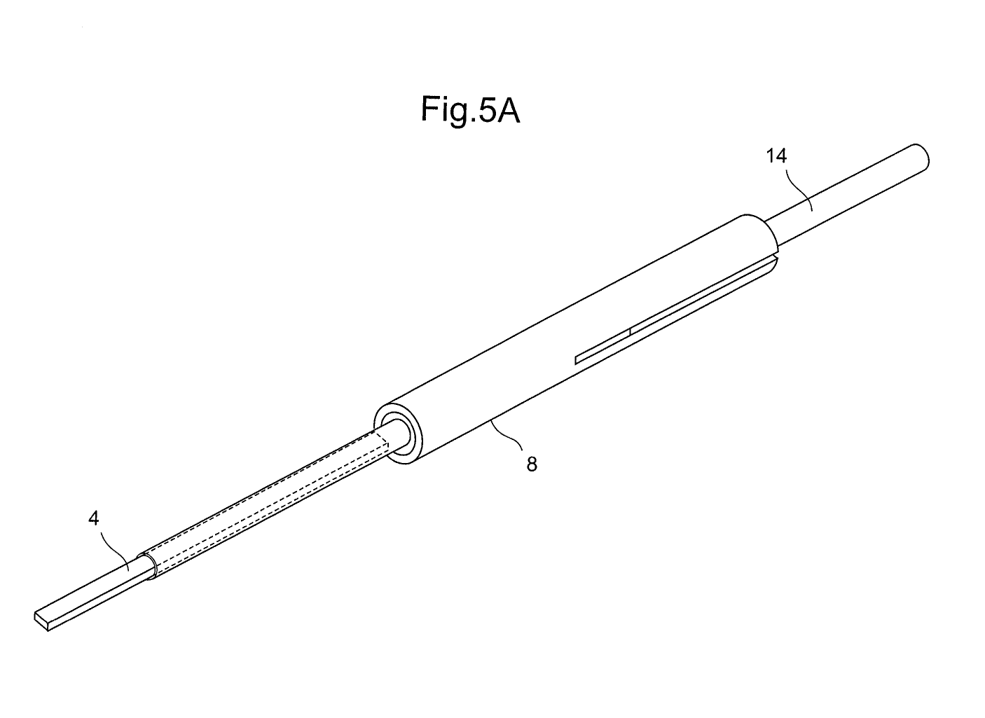

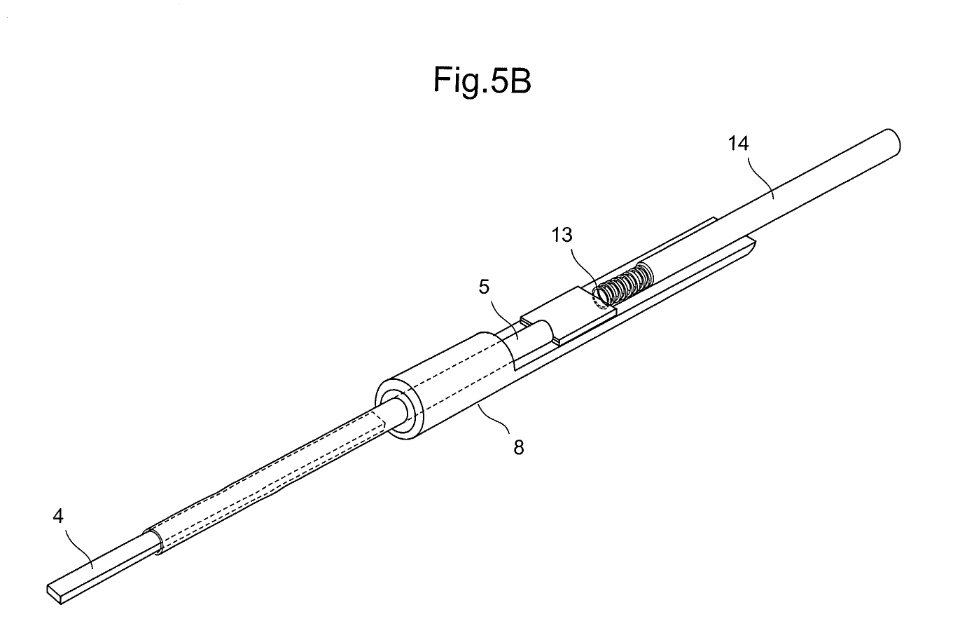

FIG. 5A shows an external view of a coupling mechanism that transmits the rotation of the motor 20 to the cleaning stick and FIG. 5B shows an internal view of the mechanism from which a part of the collar 8 is cut away. This mechanism comprises the shaft 14, spring 13, collar 8, holder 5, and cleaning stick 4, transmits the rotation of the motor 20 to the cleaning stick 4 while pressing the cleaning stick 4 against the optical connector with a constant force.

The collar 8 containing the spring 13 couples the shaft 14 with the holder 5 containing the cleaning stick 4. The collar 8 is of perforated cylindrical shape and has two slits in the wall of the cylinder that are symmetric with respect to a center axis near the half of the cylinder in the direction of the length. The holder 5 of the cleaning stick has the shape of an elongated rod and the end of which opposite to the end at which the cleaning stick 4 is inserted is a rectangular plate in shape as shown in FIG. 5B. The rectangular plate end is inserted into the slits provided in the collar 8. After the holder 5 is inserted, the spring 13 is inserted into the holder 8 and the shaft 14 is fitted into the holder 8 having the slits. Because the cleaning stick 4 has the structure in which the spring 13 presses the cleaning stick 4 against the optical connector's connecting-end-face 1b through the holder 8 as described above, no excessive force is applied to the cleaning stick 4 nor the optical connector's connecting-end-face by the main body 24 and the cleaning stick 4 can be pressed against the optical connector with a constant force which does not vary from operator to operator.

The force that presses the cleaning stick 4 against the optical connector's connecting-end-face can always be adjusted to an optimum value by appropriately adjusting the position of the stopper 6 and the spring constant of the spring 13. The cleaning effect of the cleaning stick 4 can be maintained even if the cleaning stick 4 is worn by repeated cleaning, because the cleaning stick 4 is pressed against the optical connector's connecting-end-face with a constant force.

The cleaning stick 4 is flat or helical in shape so as to facilitate the production of a current of air by its rotation. Thus, the rotation of the cleaning stick 4 helps scrape dust off the optical connector's connecting-end-face 1b and produces the current of air rotating around the optical connector's connecting-end-face 1b to let out the scraped dust into the current of air. In addition, the groove provided on the surface of the cleaning stick 4 produces a stronger air current, thereby ensuring that the dust is removed more reliably. It is required that the rotation center of the tip of the cleaning stick 4 is slightly off the axis of the optical connector's connecting-end-face 1b in order to let out the dust. The slightly eccentric rotation can be achieved by providing a manufacturing or fabrication deviation to components of the rotation mechanism of the present invention.

When the force that pushes the cleaning mechanism main body into the optical connector housing 2 is removed after the completion of cleaning, the collar 11 and the spring 16 are disconnected from each other, power supply to the motor 20 is shut, and the cleaning stick 4 stops rotating. The dust blown out into the air current by the rotational force of the cleaning stick 4 is let out into outside air when the attachment 3 is pulled out from the optical connector housing.

While the embodiment has been described with respect to an optical connector housing for dual connector, the present invention can be applied to various types of optical fiber connectors, including array structure connectors, by making changes to the structure of the housing.

The present invention is also applicable to a plastic optical fiber in addition to the quartz and glass optical fiber.

Cleaning using the optical connector's connecting-end-face cleaning mechanism according to the present invention has the following advantages.

First, contamination such as lint from a cleaning tool itself as in the prior-art cleaning using tools such as a cotton swab can be avoided. Second, dozens of cleanings can be performed without replacing a cleaning tool. Third, the cleaning can be performed simply by pushing the cleaning mechanism into the optical connector with one hand, does not require skill and therefore can be done with ease regardless of worker.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A cleaning method of removing contamination from a connecting-end-face of an optical connector, comprising the step of:
pressing the tip of a cleaning stick made of a material softer than the material of said optical connector's end-face against said optical connector's end-face with a predetermined, constant force; and
using a mechanism for rotating said cleaning stick about a center axis along said cleaning stick to remove the contamination from said optical connector's end-face, said center axis deviating from the center of said optical connector's end-face.

2. The optical connector's connecting-end-face cleaning method according to claim 1, wherein said cleaning stick starts rotating before said cleaning stick is pressed against said optical connector's connecting-end-face.

3. The optical connector's connecting-end-face cleaning method according to claim 1, wherein a cross-section of said cleaning stick perpendicular to an axis of said cleaning stick is rectangular in shape.

4. The optical connector's connecting-end-face cleaning method according to claim 3, wherein a shape of said cleaning stick along its axis is a helix.

5. The optical connector's connecting-end-face cleaning method according to claim 3, wherein said cleaning stick has a groove on its surface along its axis.

6. The optical connector's connecting-end-face cleaning method according to claim 3, wherein a direction of a rotation of said cleaning stick is determined so as to produce a current of air flowing away from the tip along the helix is produced when said cleaning stick rotates.

7. An optical connector's connecting-end-face cleaning mechanism that brings a tip of a cleaning stick for cleaning the optical connector's connecting-end-face into contact with said end-face to clean said optical connector's connecting-end-face, comprising:
an attachment into which a tip of said cleaning mechanism containing said cleaning stick and said optical connector are fitted coaxially from opposing directions; and
means for rotating said cleaning stick about a center axis along said cleaning stick and pressing the tip of said cleaning stick against said optical connector's connecting-end-face.

8. The optical connector's connecting-end-face cleaning mechanism according to claim 7,
wherein a depth at which said tip is fitted into said attachment is predetermined and said means for rotating said cleaning stick and pressing said cleaning stick against said optical connector's connecting-end-face comprises means for exposing the tip of said cleaning stick from the tip of said cleaning mechanism when said tip of said cleaning mechanism is further pressed toward said optical connector from said predetermined depth.

9. The optical connector's connecting-end-face cleaning mechanism according to claim 7, wherein the rotation of said cleaning stick is an eccentric rotation.

10. The optical connector's connecting-end-face cleaning mechanism according to claim 7, wherein the force pressing the tip of said cleaning stick against said optical connector's connecting-end-face is a predetermined, constant force.

11. The optical connector's connecting-end-face cleaning mechanism according to claim 7, wherein said cleaning stick starts rotating before said cleaning stick is pressed against said optical connector's connecting-end-face.

12. The optical connector's connecting-end-face cleaning mechanism according to claim 7, wherein a material of said cleaning stick is softer than a material of said optical connector's connecting-end-face.

13. The optical connector's connecting-end-face cleaning mechanism according to claim 7, wherein a cross-section of said cleaning stick perpendicular to the axis of said cleaning stick is rectangular in shape.

14. The optical connector's connecting-end-face cleaning mechanism according to claim 13, wherein a shape of said cleaning stick along its axis is a helix.

15. The optical connector's connecting-end-face cleaning mechanism according to claim 13, wherein said cleaning stick has a groove on its surface along its axis.

16. The optical connector's connecting-end-face cleaning mechanism according to claim 14, wherein the direction of the rotation of said cleaning stick is determined so as to produce a current of air flowing away from the tip along the helix is produced when said cleaning stick rotates.

17. An optical connector's connecting-end-face cleaning mechanism that brings the tip of a cleaning stick into contact with an optical connector's connecting-end-face to clean the optical connector's connecting-end-face,
wherein said optical connector's connecting-end-face cleaning mechanism comprises an attachment and a cleaning mechanism main body, and
the tip of said cleaning mechanism contains said cleaning stick passing though it and said optical connector are coaxially fitted into said attachment from opposing directions at their respective predetermined depths;
said cleaning mechanism main body comprises said tip and a holder;
said holder is coupled with said tip through a first coil spring to fit said tip against the inner wall of said holder and slidablly hold said tip, and
said holder comprises a motor;
a power supply for driving said motor;
a mechanism for transmitting the rotation of said motor to said cleaning stick through a second coil spring;
and a third coil spring located in the cylinder hollow of said first coil spring for performing switching operation for connecting and disconnecting said motor to and from said power supply by electrical connection and disconnection with and from the first coil spring.

18. The optical connector's connecting-end-face cleaning mechanism according to claim 17,
wherein when said holder is pushed toward said optical connector after the tip of said cleaning mechanism main body is fitted into said attachment at a predetermined depth, said cleaning stick rotates about a center axis along said cleaning stick, the tip of said cleaning stick contained in said tip of said cleaning mechanism main body is exposed from said tip of said cleaning mechanism, and the tip of said cleaning stick is pressed against said optical connector's connecting-end-face with a predetermined, constant force.

19. The optical connector's connecting-end-face cleaning mechanism according to claim 18,
wherein said cleaning stick starts rotating when said holder is pushed toward said optical connector to retract said first coil spring and electrically connect said first coil spring to said third coil spring, and stops rotating when said holder is pulled back from said optical connector to stretch said first coil spring to disconnect said first coil spring from the third coil spring.

20. The optical connector's connecting-end-face cleaning mechanism according to claim 18,
wherein said tip of said cleaning mechanism further comprises a stopper for inhibiting said holder from moving beyond a predetermined distance toward said optical connector, and
the tip of said cleaning stick is exposed from the tip of said cleaning mechanism when said holder is pushed toward said optical connector to retract said first coil spring and a mechanism for transmitting the rotation of said motor to said cleaning stick through said second coil spring pushes out said cleaning stick through the hollow of the tip of said cleaning mechanism.

21. The optical connector's connecting-end-face cleaning mechanism according to claim 18,
wherein said tip of said cleaning mechanism further comprises a stopper for inhibiting said holder from moving beyond a predetermined distance toward said optical connector;
the tip of said cleaning stick is pressed against said optical connector's connecting-end-face when said holder is stopped by said stopper; and
said predetermined, constant force is set by the position of said stopper and the spring constant of said second coil spring.

22. The optical connector's connecting-end-face cleaning mechanism according to claim 17,
wherein said cleaning stick starts rotating before said cleaning stick is pressed against said optical connector's connecting-end-face.

23. The optical connector's connecting-end-face cleaning mechanism according to claim 17,
wherein the rotation of said cleaning stick is eccentric rotation.

24. The optical connector's connecting-end-face cleaning mechanism according to claim 17,
wherein the cross-section of said cleaning stick perpendicular to the axis of said cleaning stick is rectangular in shape.

25. The optical connector's connecting-end-face cleaning mechanism according to claim 24,
wherein the shape of said cleaning stick along its axis is a helix.

26. The optical connector's connecting-end-face cleaning mechanism according to claim 24,
wherein said cleaning stick has a groove on its surface along its axis.

27. The optical connector's connecting-end-face cleaning mechanism according to claim 25,
wherein the direction of the rotation of said cleaning stick is determined so as to produce a current of air flowing away from the tip along the helix is produced when said cleaning stick rotates.
